(19) United States
(12) Patent Application Publication
(10) Pub. No.: US 2002/0130102 A1
(43) Pub. Date: Sep. 19, 2002

(54) Method of forming a thin-film resistor employed in a semiconductor water

(76) Inventor: Jia-Sheng Lee, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 09/803,883

(22) Filed: Mar. 13, 2001

(51) Int. Cl. H01B 13/00

(52) U.S. Cl. 216/16

(57) ABSTRACT

The present invention provides a method of forming a thin-film resistor positioned on a semiconductor wafer. The method comprises forming a resistance layer and an insulating layer in a predetermined area of the dielectric layer, the insulating layer being positioned on the resistance layer; performing a first etching process to remove the insulating layer on two ends of the resistance layer to form two openings; forming a conductive layer on the insulating layer and filling the two openings, the conductive layer being electrically linked with the two ends of the resistance layer from the two openings; and performing a second etching process to remove the conductive layer outside the resistance layer and partial conductive layer on the insulating layer to form two disconnected conductive layers, the two openings being separately positioned below the two disconnected conductive layers.

The thin-film resistor comprises a dielectric layer positioned on the semiconductor, a resistance layer positioned in a predetermined area of the dielectric layer, an insulating layer positioned on the resistance layer and comprising two openings on two ends of the resistance layer, and two conductive layers separately positioned in the two openings and protruding from the insulating layer for electrically linking the two ends of the resistance layer as two electrical terminals of the resistance layer.

### BACKGROUND OF THE INVENTION

1. Field of the Invention

The present invention relates to method of forming a thin-film resistor, and more particularly to a method of forming a thin-film resistor employed in a semiconductor wafer.

2. Description of the Prior Art

A thin-film resistor provides stable resistance on a semiconductor wafer. However, the resistance becomes unstable if the resistance layer is not uniform in thickness. The resistance of the resistance layer is greatest at its thinnest regions and lowest at its thickest regions. This unstable resistance may adversely affect the functioning of the thin-film resistor.

Please refer to FIG. 1. FIG. 1 is a sectional schematic diagram of the thin-film resistor 20 positioned on the semiconductor wafer 10 according to the prior art. A thin-film resistor 20 positioned on a semiconductor wafer 10 comprises a first dielectric layer 12, two conductive layers 14, a second dielectric layer 16, and a resistance layer 18. The first dielectric layer 12 is positioned on the semiconductor wafer 10. The two conductive layers 14 are positioned in a predetermined area of the first dielectric layer 12. The second dielectric layer 16 is positioned on the two conductive layers 14 and comprises two separate openings. Each of these openings are located on each of two conductive layers 14. The resistance layer 18 is positioned in a predetermined area of the second dielectric layer 16 and fills the two openings. Due to the fact that the two ends of the two conductive layers 14 are in separate contact with the resistance layer 18, the two conductive layers 14 function as electrical terminals of the resistance layer 18 when the semiconductor wafer 10 electrically links to external components.

In processing the thin-film resistor 20, the two conductive layers 14 are positioned in the predetermined area of the first dielectric layer 12 first. This makes the surface of the semiconductor wafer 10 uneven. As the second dielectric layer 16 and the resistance layer 18 are sequentially deposited onto the semiconductor wafer 10, step coverage becomes a problem as the thickness of the resistance layer 18 becomes uneven. This causes degradation of the entire process. Where the resistance layer 18 is thinner, connection with the conductive layers 14 results in greater resistance. Conversely, a lower resistance results in areas where the resistance layer 18 is thicker. Clearly, the irregularity of thickness in the resistance layer 18 leads to unstable resistance.

### SUMMARY OF THE INVENTION

It is therefore a primary objective of the present invention to provide a method of forming a thin-film resistor employed in a semiconductor wafer for preventing the resistance of the thin-film resistor from becoming unstable due to uneven thickness of the resistance layer.

In a preferred embodiment, the present invention provides a method of forming a thin-film resistor on a dielectric layer positioned on a semiconductor wafer, the method comprising:

forming a resistance layer and an insulating layer in a predetermined area of the dielectric layer, the insulating layer being positioned on the resistance layer;

performing a first etching process to remove the insulating layer on two ends of the resistance layer to form two openings;

forming a conductive layer on the insulating layer and filling the two openings, the conductive layer being electrically linked with the two ends of the resistance layer from the two openings; and

performing a second etching process to remove the conductive layer outside the resistance layer and partial conductive layer on the insulating layer to form two disconnected conductive layers, the two openings being separately positioned below the two disconnected conductive layers.

It is an advantage of the present invention that the method of forming the thin-film resistor comprises forming a resistance layer evenly positioned on a dielectric layer so as to prevent the resistance from being unstable.

This and other objective of the present invention will no doubt become obvious to those of ordinary skill in the art after having read the following detailed description of the preferred embodiment which is illustrated in the various figures and drawings.

### BRIEF DESCRIPTION OF THE DRAWINGS

FIG. 1 is a sectional schematic diagram of the thin-film resistance positioned on the semiconductor wafer according to the prior art.

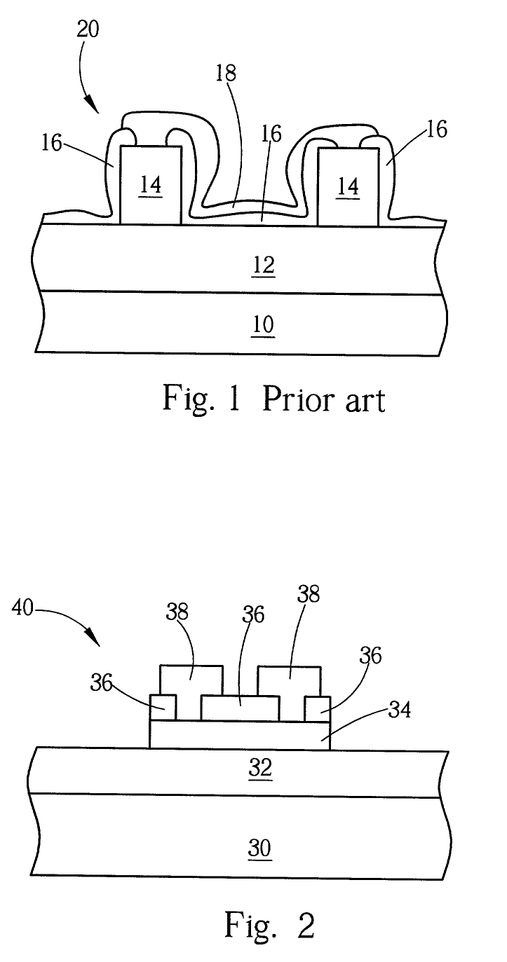

FIG. 2 is a sectional schematic diagram of the thin-film resistance positioned on the semiconductor wafer according to the present invention.

FIG. 3 to FIG. 8 are schematic diagrams of a method of forming the thin-film resistor positioned on the semiconductor wafer shown in FIG. 2.

### DETAILED DESCRIPTION OF THE PREFERRED EMBODIMENT

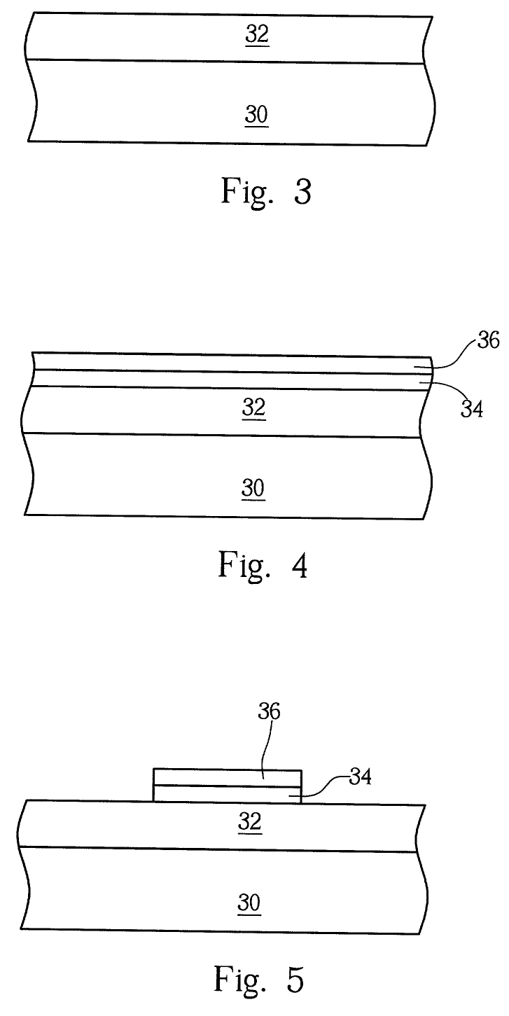

Please refer to FIG. 2. FIG. 2 is a sectional schematic diagram of the thin-film resistor 40 positioned on the semiconductor wafer 30 according to the present invention. A thin-film resistor 40 positioned on a semiconductor wafer 30 comprises a dielectric layer 32, a resistance layer 34, an insulating layer 36, and two conductive layers 38. The dielectric layer 32 formed of borophosphosilicate glass (BPSG) is positioned on the semiconductor wafer 30. The resistance layer 34 formed of SiCr (chromium silicon) is positioned in a predetermined area of the dielectric layer 32. The insulating layer 36 formed of silicon dioxide is positioned on the resistance layer 34 and comprises two openings on two ends of the resistance layer 34. The two conductive layers 38 both formed of an aluminum-based metal alloy are positioned separately in the two openings and protrudes from the insulating layer 36. The two conductive layers 38 separately electrically link the two ends of the resistance layer 34 and can be used as the electrical terminals of the resistance layer 34.

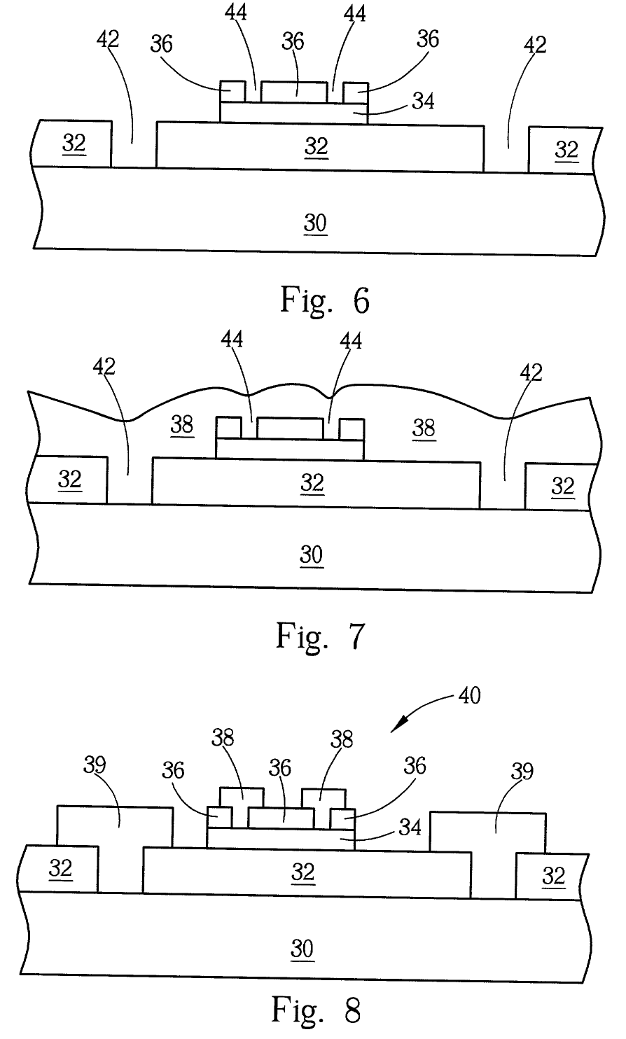

Please refer to FIG. 3 to FIG. 8. FIG. 3 to FIG. 8 are schematic diagrams of a method of forming the thin-film resistor positioned on the semiconductor wafer shown in FIG. 2. As shown in FIG. 3, the thin-film resistor 40 is formed on the dielectric layer 32. This dielectric layer 32 is positioned on the semiconductor wafer 30. First, the resistance layer 34 is formed on the dielectric layer 32, and then the insulating layer 36 is formed on the resistance layer 34 by using a chemical vapor deposition process as shown in FIG. 4. Next, an anisotropic dry-etching process is performed to remove the resistance layer 34 and the insulating layer 36 outside of the predetermined area as shown in FIG. 5.

Next, a first etching process is performed to remove the insulating layer 36 on the two ends of the resistance layer 34 to form two openings 44 as shown in FIG. 6. The first etching process comprises a wet-etching process that employs buffered oxide etcher (BOE) as the etching solution. Next, a conductive layer 38 is formed on the insulating layer 36 that fills the two openings 44 as shown in FIG. 7. Finally, a second etching process is performed to remove the areas of the conductive layer 38 outside of the resistance layer 34 as well as a portion of the conductive layer 38 on the insulating layer 36. This leads to the formation of two disconnected conductive layers 38. The two openings 44 are separately positioned below the two disconnected conductive layers 38 and electrically link the two conductive layers 38 with the two ends of the resistance layer 34 as shown in FIG. 8.

Also, a contact hole etching process can be performed to form at least one contact hole 42 outside of the predetermined area of the dielectric layer 32 prior to the formation of the conductive layer 38 (FIG. 6). The conductive layer 38 then fills both the openings 44 as well as the contact hole 42 (FIG. 7). In performing the second etching process, the conductive layer 38 on the dielectric layer 32 is partially removed to form disconnected conductive layers 39 on each contact hole 42 (FIG. 8). Each conductive layer 39 electrically links with the devices of the semiconductor wafer 30 through each contact hole 42. The contact hole 42 formed by dry-etching is different from the two openings 44 formed by wet-etching. Plasma damage to the resistance layer 34 resulting from simultaneous formation of the contact hole 42 and opening 44 through dry-etching is prevented. Further, when the contact hole 42 and the two openings 44 are formed separately, the process parameters can be set properly depending on corresponding etching regions. This leads to better control of etching time and more accurate depth of etching.

Since the dielectric layer 32 has a level surface, the resistance layer 34 positioned on top has a uniform thickness. The two conductive layers 38 electrically link with the two ends of the resistance layer 34 and the resistance of the thin-film resistor 40 is stable.

Compared to the prior art of the thin-film resistor 20, a thin-film resistor 40 employed in a semiconductor wafer 30 of the present invention has an even resistance layer 34 that is formed on a dielectric layer 32. Then, two conductive layers 38 are separately positioned in two openings 44 of an insulating layer 36 positioned on the resistance layer 34. The two conductive layers 38 electrically link separately to the two ends of the resistance layer 34 to form the thin-film resistor 40. The even resistance layer 34 results in stability of resistance.

Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method of forming a thin-film resistor on a dielectric layer positioned on a semiconductor wafer, the method comprising:
forming a resistance layer and an insulating layer in a predetermined area of the dielectric layer, the insulating layer being positioned on the resistance layer;
performing a first etching process to remove the insulating layer on two ends of the resistance layer to form two openings;
forming a conductive layer on the insulating layer and filling the two openings, the conductive layer being electrically linked with the two ends of the resistance layer from the two openings; and
performing a second etching process to remove the conductive layer outside the resistance layer and partial conductive layer on the insulating layer to form two disconnected conductive layers, the two openings being separately positioned below the two disconnected conductive layers.

2. The method of claim 1 further comprising a contact hole etching process in which at least one contact hole is formed prior to the formation of the conductive layer, and the contact hole is filled by the conductive layer when the conductive layer is formed.

3. The method of claim 1 wherein the resistance layer and the insulating layer are formed in the predetermined area by using the following steps:
forming the resistance layer on the dielectric layer;
forming the insulating layer on the resistance layer; and
performing an anisotropic dry-etching process to remove the resistance layer and the insulating layer outside the predetermined area.

4. The method of claim 1 wherein the first etching process comprises a wet-etching process for forming the two openings.

5. The method of claim 4 wherein the wet-etching process employs buffered oxide etcher (BOE) as the etching solution.
